(19) United States
(12) Patent Application Publication
(10) Pub. No.: US 2011/0207081 A1
(43) Pub. Date: Aug. 25, 2011

(54) Endodontic Drill Bit

(75) Inventor: Steven D. Jensen, South Jordan, UT (US)

(73) Assignee: CAO GROUP, INC., West Jordan, UT (US)

(21) Appl. No.: 13/034,694

(22) Filed: Feb. 24, 2011

Related U.S. Application Data
(60) Provisional application No. 61/307,538, filed on Feb. 24, 2010.

(51) Int. Cl. A61C 3/06; A61C 5/02

(52) U.S. Cl. 433/166; 433/224

(57) ABSTRACT

Embodiments of the present invention include devices and methods that provide an effective endodontic drill bit to drill postholes for use in root canals and similar or related dental procedures. In particular, example embodiments of the present invention provide an endodontic drill bit that can be used by a dental professional to drill a posthole with a particular diameter, while at the same time causing the side wall surfaces of the posthole to include a texture that can increase the mechanical retention of a dental post in the posthole. In example embodiments, the endodontic drill bit includes an abrasive grit that is attached or is part of the land of the endodontic drill bit.

### CROSS-REFERENCE TO RELATED APPLICATIONS

This application claims priority of U.S. Provisional Application No. 61/307,538, filed Feb. 24, 2010, which is incorporated herein by reference in its entirety.

### TECHNICAL FIELD OF THE INVENTION

The present disclosure generally relates to the field of dental instruments and tools, and more particularly, to dental drills for use in performing various dental procedures.

### BACKGROUND OF THE INVENTION

As a tooth decays, the structure of the tooth weakens. Additionally, when the decay reaches the pulp portion of the tooth, the tooth usually becomes a necrotic tooth. Often times, the best treatment for a necrotic tooth is have a dental professional remove the necrotic pulp by way of a root canal or similar dental procedure. During a root canal, the dental profession may remove a significant amount of tooth structure to gain access to the pulp chamber and root canal. After a root canal is performed, the dental professional seals the root end and prepares the tooth to receive a prosthetic crown.

In order to prepare the tooth to receive a prosthetic crown, the dental professional may drill a posthole in an upper section of the root canal to facilitate the reception of a reinforcing dental post. The dental post may be made of metal, fiber, composite, cement, fiber reinforced polymers, and other similar materials. In one example procedure, the dental professional may cement the dental post into the posthole in the upper section, after which the dental professional builds a core around the post to create an opposing surface for which to attach the prosthetic crown. The purpose of the dental post is to reinforce the core which, in turn, reinforces the tooth. Therefore, the more retentive the dental post is within the posthole, the greater the overall reinforcement of the prosthetic crown.

One factor that affects the retention of the dental post within the posthole may be the surface characteristics of the side walls of the posthole. For example, smooth and flat surfaces are typically more difficult to bond compared to surfaces that include uneven or rough surface characteristics. In particular, postholes that have smoothed and flat surfaces do not mechanically retain a dental post, but almost solely rely on chemical retention between the cement and the actual tooth surface within the posthole. Chemical retention alone is often not enough to adequately reinforce the dental post in the posthole and may lead to problems with the prosthetic crown being reinforced over a period of time.

On the other hand, mechanical retention may greatly increase the reinforcement of the dental post in the posthole. Mechanical retention of an dental post is possible if the posthole includes rough surfaces because the cement may flow into the uneven rough surfaces of the posthole. After curing, the cement acts as a hook or similar device that may interface or engage with the rough surfaces of the tooth to provide a mechanical retention feature that increases the overall reinforcement of the prosthetic crown.

Conventional endodontic drill bits used to make the postholes are similar to what can be considered conventional metal or wood drill bits. Due to the conventional endodontic drill bit design that includes flat and smooth lands, conventional endodontic drill bits typically bore a posthole with smooth surfaces. In other words, the side walls of the posthole are smooth and flat, which may not provide the necessary mechanical retention as discussed above.

Due to the limitations of conventional endodontic drill bits, the dental professional either has to make do with a chemical retention method and risk failure, or the dental professional has to roughen the surfaces of the posthole in a second step. Unfortunately, many times upon attempting to roughen the surface of the posthole, the dental professional ends up affecting the diameter of the posthole. For example, the dental professional may inadvertently increase the diameter of the posthole such that the posthole and post no longer have a precise fit that affects the stability of the prosthetic crown.

Accordingly, there are a number of disadvantages in the conventional art of endodontic drill bits.

### SUMMARY OF THE INVENTION

Embodiments of the present invention include devices and methods that provide an effective endodontic drill bit to drill postholes for use in root canals and similar or related dental procedures. In particular, example embodiments of the present invention provide an endodontic drill bit that can be used by a dental professional to drill a posthole with a particular diameter, while at the same time causing the side wall surfaces of the posthole to include a texture that can increase the mechanical retention of a dental post in the posthole. In example embodiments, the endodontic drill bit includes an abrasive grit that is attached or is part of the land of the endodontic drill bit.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific example implementations thereof which are illustrated in the appended drawings. Understanding that these drawings depict only example embodiments of the invention and are not therefore to be considered to be limiting of its scope, the invention will be described and explained with additional specificity and detail through the use of the accompanying drawings in which:

FIG. 1 illustrates an example embodiment of an endodontic drill according to the present invention; and

FIG. 2 illustrates an example method according to the present invention.

### DETAILED DESCRIPTION OF THE INVENTION

Embodiments of the present invention include devices and methods that provide an effective endodontic drill bit to drill postholes for use in root canals and similar or related dental procedures. In particular, example embodiments of the present invention provide an endodontic drill bit that can be used by a dental professional to drill a posthole with a particular diameter, while at the same time causing the side wall surfaces of the posthole to include a texture that can increase the mechanical retention of a dental post in the posthole. In example embodiments, the endodontic drill bit includes an abrasive grit that is attached or is part of the land of the endodontic drill bit.

As will be appreciated more fully herein, embodiments of the present invention provide an endodontic drill bit that a dental professional can use to drill an accurate dimensioned posthole while simultaneously preparing the side wall surface of the posthole for optimal retention of a dental post. For example, a dental professional does not have to perform a two step process in order to create a texture on the side wall surface of the posthole. Moreover, because no second step is needed, the dentist can drill a posthole with an accurate diameter configured to accept a predetermined size of dental post.

Additionally, the endodontic drill bit allows the dental professional to perform a root canal or similar dental procedure in a time efficient manner, which saves time and money compared to conventional methods. Notwithstanding the fact that the endodontic drill bit provides a more efficient process, the endodontic drill bit further provides a superior overall retention mechanism to secure a prosthetic crown or similar device to a patient's tooth.

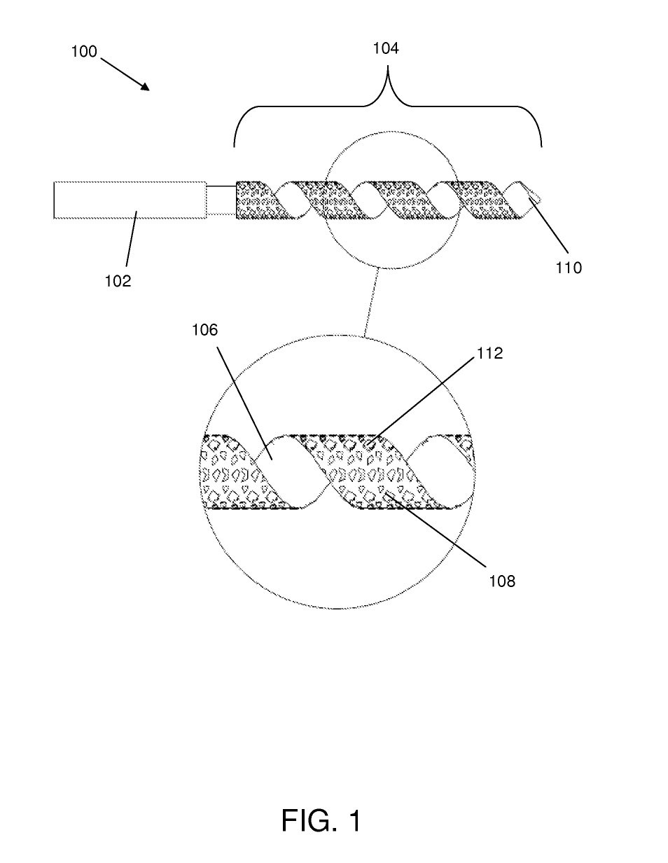

An example embodiment of an endodontic drill bit 100 is illustrated in FIG. 1. The endodontic drill bit 100 can include a shank 102 configured to interface with a dental drill assembly (not shown) that includes a motor for driving the rotation of the endodontic drill bit 100. As illustrated in FIG. 1, the shank 102 has a cylindrical configuration. In alternative embodiments, however, the shank 102 can have a square, rectangular, triangular, or any other configuration that may be required to fit into a variety of dental drill assemblies. Similarly, the dimensions of the shank 102 can vary from one embodiment to the next, including the diameter and length of the shank 102.

The shank 102 can transition to a cutting portion 104 of the endodontic drill bit 100, as illustrated in FIG. 1. The cutting portion 104 of the endodontic drill bit 100 can have various configurations depending on the style or type of drill bit. For example, as illustrated in FIG. 1, the cutting portion 104 can have a twist drill bit configuration. In alternative embodiments, the cutting portion 104 can have a step, unibit, core, center, multi-fluted, countersink, spade, lip and spur, spoon, forstner, auger, gimlet, sinker, or any other drill bit type or configuration.

Just as the configuration of the cutting portion 104 can vary, so too the can the base material of the cutting portion vary from one embodiment to the next. For example, the material of the cutting portion can be tungsten carbide. However, alternative materials may include steels, steel alloys, and other similar materials. Additionally, the cutting portion 104 overall dimensions can vary from one embodiment to the next to provide the sizes necessary to accommodate different tooth sizes or root canal sizes.

The cutting portion 104 can include various portions that aid in the drilling process. For example, the cutting portion 104 can include a flute portion 106 and a land portion 108 in the twist configuration illustrated in FIG. 1. The cutting portion 104 can further include a cutting edge 110 that is configured to cleanly cut the tooth structure. Depending on the overall configuration of the endodontic drill bit 100, the cutting portion 104 can further include typical portions to aid in the drilling process, such as a heel, chisel edge, and margin portions or any other portion that is part of a particular drill bit configuration. The various portions of the cutting portion 104 can be arranged with varying angles, sizes, and relative dimensions to create various endodontic drill bits 100 with various cutting properties.

Notwithstanding the various configurations of the cutting portion 104, FIG. 1 illustrates that the endodontic drill bit 100 can include an abrasive grit 112 on the land portion 108. The abrasive grit 112 is positioned on the land portion 108 such that the abrasive grit 112 interfaces with the sidewalls of a posthole during the drilling process. As the abrasive grit 112 interfaces with the sidewalls of the posthole, the abrasive grit forms a texture on the sidewalls, e.g., causing the sidewalls to have an unsmooth surface. The texture on the sidewalls results in an improved mechanical retention of a dental post within the posthole, as will be described further below.

The material with which the abrasive grit 112 is formed can vary from one embodiment to the next. For example, in one embodiment the abrasive grit 112 is formed from a diamond material. For example, the diamond material, such as diamond powder, can be positioned on the land 108 by sintering, metal bonding, resin bonding or any other bonding technique. Other materials may also be used to form the abrasive grit 112. For example, titanium nitride, titanium aluminum nitride, titanium carbon nitride, zirconium nitride, zirconia, silica carbide, or similar materials may be used as the abrasive grit 112.

The surface density of the abrasive grit 112 can vary from one embodiment to the next to achieve various degrees of abrasiveness. As illustrated in FIG. 1, the surface density of the abrasive grit 112 can be about 50% or more of the land portion's 108 surface area. In other example embodiments, the surface density of the abrasive grit 112 can be higher such that up to about 100% of the surface area of the land portion 108 is the abrasive grit 112. In other example embodiments, the abrasive grit 112 surface density can be lower than 50%, for example, the surface density can be as low as about 5% or lower.

Just as the surface density of the abrasive grit 112 can vary from one embodiment to the next, the portion of the land portion 108 that is covered by the abrasive grit 112 can vary. For example, FIG. 1 illustrates one example embodiment where about the entire land portion 108 is covered with the abrasive grit 112 having a certain surface density. In alternative embodiments, only a portion of the land portion 108 can be covered with the abrasive grit 112. Moreover, FIG. 1 illustrates that almost the entire cutting portion 104 can include abrasive grit 112, but in other example embodiments, only a portion of the cutting portion 104 can be covered with the abrasive grit 112. For example, only half, one quarter, or even less of the cutting portion 104 can have the abrasive grit 112.

In addition, the abrasive grit 112 can have various engineered individual grain configurations to achieve a desired texture or pattern within the posthole. As illustrated in FIG. 1, the individual grain configuration can be an irregular shape. Moreover, the individual grains can have a random irregular shape that varies from one individual grain to the next, as illustrated in FIG. 1. In alternative embodiments, the individual grains can have a standardized shape depending on the particular application. For example, the individual grains can be engineered to have a substantially spherical shape.

Similarly, the individual grains that make up the abrasive grit 112 can have various sizes to achieve a desired surface finish. Table 1 lists example individual grain sizes that can be used to make the abrasive grit 112 and the corresponding surface finish for each grain size. In some embodiments, various different individual grain sizes and shapes can be combined to achieve a desired surface finish within the posthole.

TABLE 1

| Grain Size | | Surface Finish |
|---|---|---|
| 0.25 to 2 | micron | Super Fine |
| 2 to 4 | micron | General Polish |
| 4-10 | micron | Course Finish |
| 10-40 | micron | Rough Dimension Finish |
| 40-120+ | micron | Very Rough Finish |

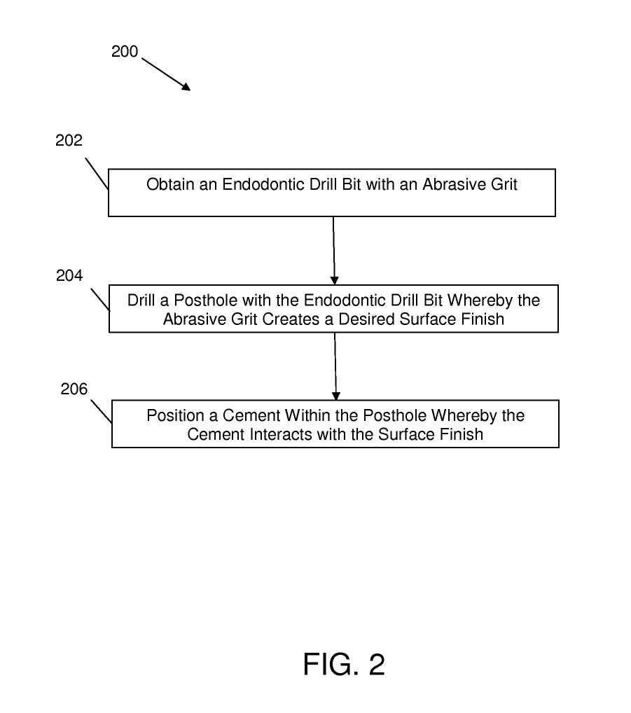

Accordingly, FIG. 1 and the corresponding text provide a number of different components and devices that provide an endodontic drill bit. In addition to the foregoing, example embodiments of the present invention can also be described in terms of flowcharts comprising one or more acts in a method for accomplishing a particular result. For example, FIG. 2 illustrates a method 200 of securing a dental post. The acts of FIG. 2 are discussed more fully below with respect to the example embodiments of the endodontic drill bit discussed with reference to FIG. 1.

For example, FIG. 2 shows that the method 200 comprises an act 202 of obtaining an endodontic drill bit with an abrasive grit. For example, FIG. 1 shows that the endodontic drill bit 100 can include a cutting portion 104 with a landing portion 108 that has an abrasive grit 112.

Also, the method 200 comprises an act 204 of drilling a posthole with the endodontic drill bit whereby the abrasive grit creates a desired surface finish. For example, the abrasive grit 112 illustrated in FIG. 1 can be engineered with various individual grain sizes and shapes to achieve a desired surface finish within the posthole without having to perform a separate step with another dental tool.

Additionally, the method 200 comprises an act 206 of positioning a cement within the posthole whereby the cement interacts with the surface finish. For example, the surface finish within the posthole can include an uneven or rough surface created by the abrasive grit, and the cement can interact and/or engage with the uneven or rough surface such that when the cement cures there is mechanical retention between the cement and the surface finish within the posthole.

Thus, the diagrams and figures provided in FIG. 1 through FIG. 2 illustrate a number of methods, devices, systems, configurations, and components that can be used to effectively drill a posthole or perform other similar dental procedures, and achieve a mechanical retention between the cement and the tooth structure.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An endodontic drill bit comprising:
a shank configured to be received by a dental drill assembly;
a cutting portion positioned on one end of the shank;
a land portion forming an outside diameter of the cutting portion; and
an abrasive grit covering at least a portion of the land portion.

2. The endodontic drill bit recited in claim 1, further comprising a flute portion.

3. The endodontic drill bit recited in claim 2, wherein the flute portion and the land portion are in a twist configuration.

4. The endodontic drill bit recited in claim 3, wherein the outside diameter is constant throughout the cutting portion.

5. The endodontic drill bit recited in claim 4, wherein the abrasive grit comprises a plurality of individual grains.

6. The endodontic drill bit recited in claim 4, wherein the abrasive grit is made from a diamond material.

7. The endodontic drill bit recited in claim 4, wherein the abrasive grit has a non-uniform and random shape.

8. The endodontic drill bit recited in claim 4, wherein the abrasive grit has a size between about 0.25 microns to about 120 microns.

9. The endodontic drill bit recited in claim 4, wherein the abrasive grit substantially covers the entire land portion.

10. The endodontic drill bit recited in claim 4, wherein the surface density of the abrasive grit is between about 25% to about 75% of the land portion surface area.

11. An drill bit for use in drilling dental postholes, comprising:
a cutting portion having a first end and a second end;
a shank connected to the first end of the cutting portion; and
a cutting edge located on the second end of the cutting portion;
wherein the cutting portion further comprises:
a flute portion and a land portion; and
an abrasive grit at least partially covering the land portion.

12. The drill bit recited in claim 11, wherein the cutting portion is made from tungsten carbide.

13. The drill bit recited in claim 12, wherein the abrasive grit covers substantially the entire surface of the land portion.

14. The drill bit recited in claim 13, wherein the abrasive grit has a surface density of at least 25% of the surface area of the land portion.

15. The drill bit recited in claim 14, wherein the abrasive grit is sintered onto the land portion.

16. The drill bit recited in claim 15, wherein the flute portion and the land portion have a twisting configuration.

17. A method of securing a dental post, comprising:
obtaining a endodontic drill bit with an abrasive grit; and
drilling a posthole with the endodontic drill bit;
wherein the abrasive grit creates a desired surface finish within the posthole.

18. The method recited in claim 17, further comprising positioning a cement within the posthole where by the cement interacts with the surface finish.

19. The method recited in claim 18, further comprising placing a dental post into the posthole.

20. The method recited in claim 19, further comprising curing the cement such that the cement engages with the surface finish to provide a mechanical retention mechanism.
